(19) United States
(12) Patent Application Publication
(10) Pub. No.: US 2019/0156062 A1
(43) Pub. Date: May 23, 2019

(54) Method and device for providing recorded, anonymized routes

(71) Applicant: Siemens Aktiengesellschaft, Munchen (DE)

(72) Inventor: Jens-Uwe Busser, Neubiberg (DE)

(21) Appl. No.: 15/999,495

(22) PCT Filed: Nov. 18, 2016
(86) PCT No.: PCT/EP2016/078101

§ 371 Date: Nov. 19, 2018

(30) Foreign Application Priority Data
Feb. 22, 2016 (DE) 10 2016 202 659.3

(51) Int. Cl. G06F 21/62; G06F 16/29; G01C 21/34; G09B 29/00; G08G 1/01

(52) U.S. Cl. CPC G06F 21/6254; G06F 16/29; G08G 1/0112; G01C 21/3484; G09B 29/007; G01C 21/3492

(57) ABSTRACT

A method for providing recorded anonymized routes, each of which indicates a spatial movement of an object from a first end point to a second end point via successive path points and which are recorded by means of a position indication for the path points and anonymized by removing object-identifying data. The method has the following steps: dividing a geographical region in which a route is contained into at least one sub-region; removing all position indications of a route within end sub-regions of the route, i.e. within the sub-regions in which at least one end point of the route is contained; and outputting the remaining position indications of the route for further analysis and/or control. The disclosed also relates to a device and a computer program product which are designed to carry out the method.

### CROSS-REFERENCE TO RELATED APPLICATIONS

This application claims priority to PCT Application No. PCT/EP2016/078101, having a filing date of Nov. 18, 2016 based off of German application No. 102016202659.3 having a filing date of Feb. 22, 2016, the entire contents of both of which are hereby incorporated by reference.

### FIELD OF TECHNOLOGY

The following relates to a method and a device for providing recorded, anonymized routes, each of which indicates a spatial movement of an object from a first end point to a second end point via successive path points and which are recorded by means of position indications for said path points and anonymized by removing object-identifying data.

### BACKGROUND

The spatial movement of an object from a start point via successive path points to a destination point is referred to as a route. A user, a natural person for example, is usually assigned here to an object. A large number of data sources are now available for tracking the spatial movement of an object or of a person. This is also known as geo-tracking. Such routes are, for example, recorded by means of the GPS location of a smartphone, a tablet, a laptop or a navigation system of a user or vehicle. Radio cell location of a mobile telephone by a mobile network operator, or a contact to WLAN or Bluetooth access points, are further sources of data. A position indication or a stopping point of an object can also be recorded when electronic payment systems and automatic telling machines are used by means of a credit or customer card. Electronic tickets or RFID cards can also be used for determining a route when they are used in public means of transport or for a purchase.

Position indications are described, in the case of GPS data, by an indication of geographical longitude and latitude and, possibly, altitude indications. Different formats such as, for example, a GPS exchange format, a Geography Markup Language (GML) format or a Keyhole Markup Language (KML) format are commonly used here. Time indications, or a time stamp, are also registered for a route or even for individual path points in addition to the position indications. Data relating to the object itself, or to the user of the located object, are usually also stored for a route. These include, for example, a vehicle license plate number, a telephone number, an IP address of a mobile telephone device, or also card numbers or master data for a credit card.

Position data can be very useful for the delivery of innovative services such as, for example, traffic congestion reports, information regarding relevant delays in rail traffic, or advice on nearby catering facilities, recorded routes also for determining and predicting an occupancy of means of transport, for the early detection and avoidance of traffic congestion.

This information about the paths covered by an object under consideration (vehicle, smartphone, etc.) also, however, permits conclusions to be drawn as to the behavior of the assigned person as well as to their personal preferences and properties. For this reason, this data is classified under data protection law as personally related or relatable data, and therefore possibly even as data requiring special protection. In some countries, personally related or relatable data may only be acquired, processed or stored on the basis of a dedicated legal basis or of a qualified declaration of consent from those concerned. If, however, this data is successfully anonymized with the agreement of those concerned, so that no relationship with persons can any longer be established, then this data is no longer deemed to be personally related or relatable, and the restrictions arising from data protection law no longer apply to further use of the data.

Usually, at least generally known, personally identifying data and pseudonyms, such as for example IP addresses or device identifiers, are removed during anonymization. In some cases, even a start or end point of a route allows extensive information to be extracted regarding the person, so that the number of people possibly coming into question for this route is very tightly limited. As a result, a so-called de-anonymization of the route is possible in spite of the removal of personally identifying or object-identifying data. A use of such route data would therefore continue to require obtaining a qualified declaration of consent from all those concerned for each new intended use, which usually, however, cannot be done at a reasonable cost. A large number of recorded routes would therefore be excluded from further processing.

### SUMMARY

An aspect relates to providing a method and a device that prevents a de-anonymization of route data, or at least makes it difficult, thus allowing it to be used for further processing.

The method according to embodiments of the invention for providing recorded, anonymized routes, each of which indicates a spatial movement of an object from a first end point to a second end point via successive path points and which are recorded by means of a position indication for said path points and anonymized by removing object-specific data, has the following steps:

a division of a geographical region in which a route is contained into at least one sub-region, a removal of all position indications of a route within the sub-region in which at least one end point of the route is contained, and an output of the remaining position indications of the route for further analysis and/or control.

Sub-regions in which at least one end point of the route is contained are also referred to below as end sub-regions. Through the removal of the position indications of a route within the end sub-regions of the route, end points of routes can only be identified very approximately. The end points are, so to speak, masked, and a de-anonymization of the route, i.e. a determination of the identity of the object or person moving through reference to the start and/or destination point, is thus no longer possible. The start or destination point here corresponds to the first or second end point of a route. The position indications for the remaining path points of the route, i.e. the path points between the end sub-regions of the route, are retained unchanged. Advantageously, the memory space required for storing the position indications of a route is reduced by the method.

In one advantageous form of embodiment, the size of the end sub-regions is configured in such a way that at least a predeterminable number of end points of routes lies within an end sub-region.

Even with knowledge of a first end point, and thereby of a first end sub-region, it is in this way made much more difficult to deduce the second end sub-region and thereby the second end point.

In one advantageous form of embodiment, all sub-regions are then configured to have the same size.

This means that the size of all the sub-regions is selected corresponding to the largest determined minimum size of the end sub-regions. This reduces the complexity of the method, since a simple division scheme can be used for the sub-regions. Thus, for example, the geographical region under consideration in quadrants of the determined minimum size can be used for definition of the sub-regions.

In another variant, the individual sub-regions are configured with different sizes.

This has the advantage that an end sub-region in which a large number of end points of routes lie can be chosen to be very small, since it is not possible to draw a conclusion as to the individual moving object due to the large number of routes. The remaining part of the route that can be used for evaluation is correspondingly larger. This is, for example, the case for end sub-regions in which public transport nodes such as, for example, a railway station or a hospital or an industrial estate are located. The size of an end sub-region in a geographical region of low population must, on the other hand, be chosen to be spatially much larger.

In one advantageous form of embodiment, the size of the individual sub-regions is oriented to geographical circumstances.

Such sub-regions comprise, for example, a specific village or an urban district or a street or adjacent regions.

In one advantageous form of embodiment, only the end point of a route and the subsequent path points of the route following the end point as far as first reaching an edge of the end sub-region are removed.

Through this, any path points of a route that leave the end sub-region and then pass once again through the same end sub-region are also retained.

The division of the geographical region in which a route is contained into sub-regions, and the removal of all position data within the end sub-regions, enables a focused masking of the end points of the route. A de-anonymization of route data through determining the precise geographical position of the first and second end points of a route is thus made significantly more difficult. The remaining position indications of the route can be output and used for a further processing without concern for data protection. The readiness of users or objects to give the owner of a data collection consent for the further use of his route data is increased in this way. It is also not necessary to obtain the consent of the user again when the anonymized data is used for other purposes. The proposed method also reduces the required storage capacity for route data, and, through a simple scheme for division into sub-regions, permits the execution with little computation.

A device according to embodiments of the invention for providing a recorded, anonymized route, which records a spatial movement of an object from a first end point via successive path points to a second end point by means of a position indication for said path points, and which is anonymized by removing object-identifying data, comprises a division unit which is designed to divide a geographical region in which a route is contained into at least one sub-region, a masking unit which is designed to remove all position indications of a route within those sub-regions in which at least one end point of the route is contained, and an output unit which is designed to output the remaining position indications for the route for further analysis and/or storage.

Such a device can prepare recorded routes in such a way that an identity of the object whose movement has been recorded as the route cannot be determined, or can only be determined with extreme difficulty. A device that is designed to carry out the method according to the above-described method steps requires a smaller memory capacity for storing the anonymized routes. The method can be carried out by a simple computing device, in particular when sub-regions of consistent size are used. On the other hand, the loss of information regarding position indications can be minimized through a dynamic size selection of the sub-regions. This is then available for further evaluation, for example for traffic management applications such as, for example, the determination of traffic congestion or for traffic requirement planning.

A corresponding computer program product (non-transitory computer readable storage medium having instructions, which when executed by a processor, perform actions) that can be loaded directly into a stored-program component and that comprises program code segments that are appropriate for carrying out the steps of the method according to embodiments of the invention can thus also be carried out on conventional computers.

### BRIEF DESCRIPTION

Some of the embodiments will be described in detail, with reference to the following figures, wherein like designations denote like members, wherein:

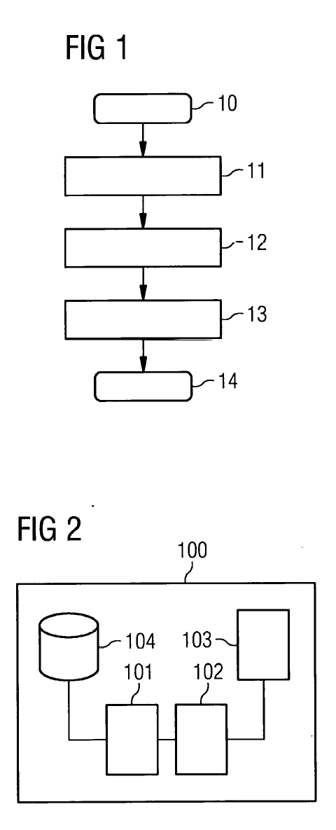

FIG. 1 shows an exemplary embodiment of the method as a flow diagram;

FIG. 2 shows a block diagram of an exemplary embodiment of a device;

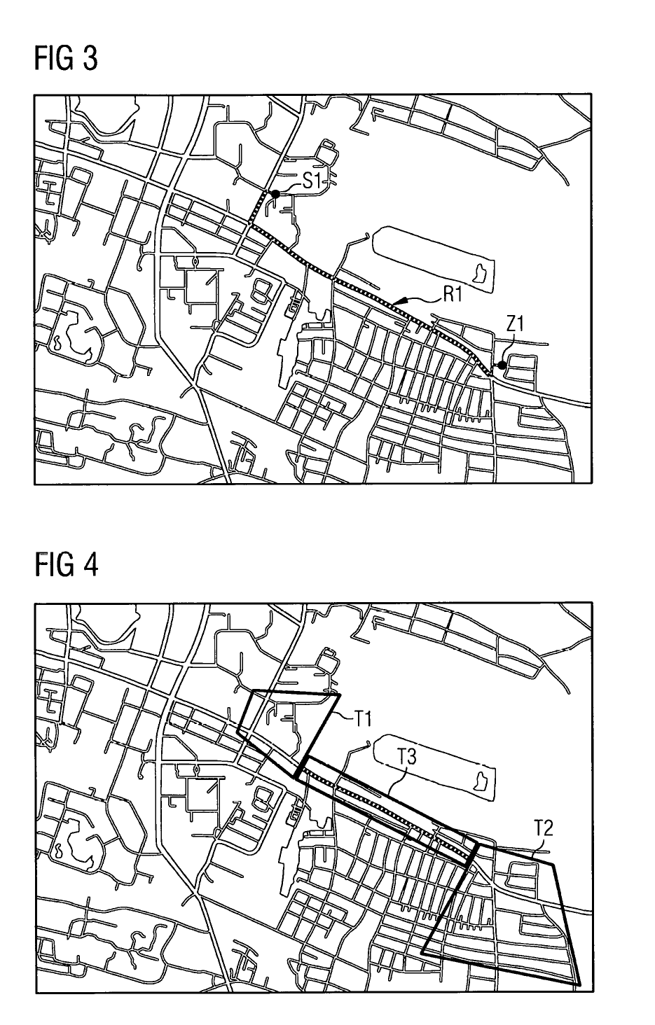

FIG. 3 shows a first example of a route in a geographical region illustrated on a roadmap;

FIG. 4 shows remaining route data when the method is applied to the route shown in FIG. 3;

FIG. 5 is an illustration of a plurality of routes in a geographical region, displayed on a roadmap; and

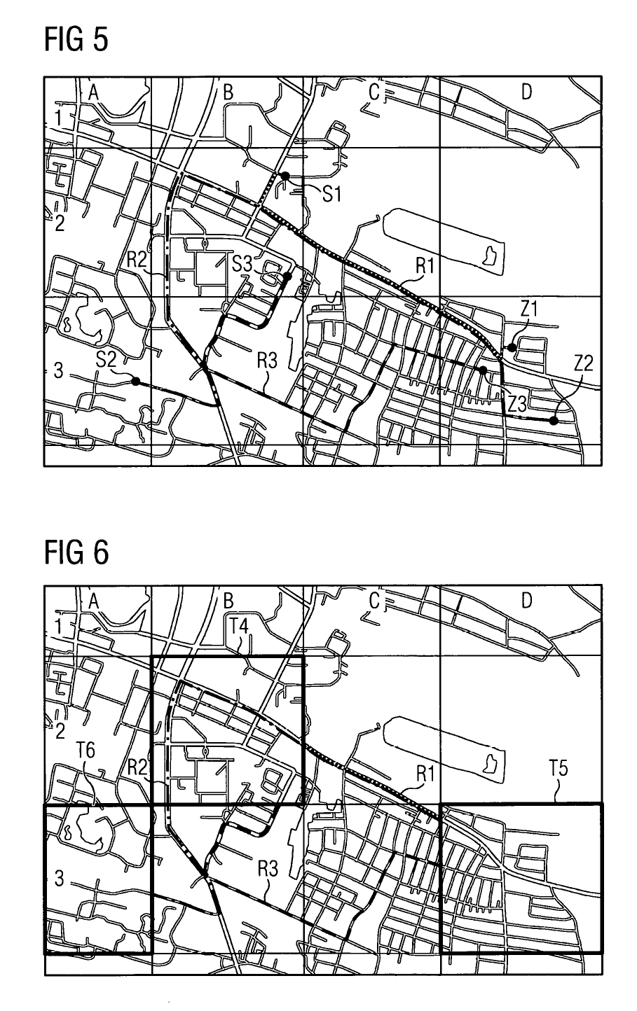

FIG. 6 shows remaining route data when the method is applied to the routes shown in

FIG. 5.

### DETAILED DESCRIPTION

Parts that correspond to one another are given the same reference signs in all the figures. The method according to embodiments of the invention will now be explained with reference to the method steps illustrated in FIG. 1 applied to the routes illustrated in FIGS. 3 to 6.

The collection and processing of route data is extremely critical in terms of data protection law, so that use of such data is heavily restricted, in particular in countries with strict data protection legislation. Use of the route data is often only possible with the consent of the user or of the moving object and/or through anonymization of the route data. An improved anonymization of the route data is now possible with the method according to embodiments of the invention, so that de-anonymization is made yet more difficult.

A flow diagram of the method is illustrated in FIG. 1. Recorded and anonymized routes are present in the initial state 10. A route is considered here as a spatial movement of an object from a first end point via successive path points to a second end point. Such a route is recorded by position indications for the path points. Object-identifying indications, such as for example the name or address of a person, a license number of a vehicle, or an IP address or device ID of, for example, a smartphone, are removed for anonymization. These recorded and anonymized data are made available for example by a memory unit or a database, for example in a server. In method step 11, a geographical region in which at least one route is contained is then divided into at least one sub-region.

In FIG. 3 a route R1 is drawn by way of example in the geographical region of a city and illustrated on a roadmap. The route R1 begins at a first end point, here start point S1, and leads via the path drawn with a dotted line to a second end point Z1, in this case the destination point of the route. The geographical region in which the route is contained is now divided into sub-regions T1, T2 and T3, see FIG. 4. The sub-regions T1, T2, T3 are for example aligned to structural features of the geographical region, in this case, by way of example, to adjacent residential areas or the road along which are main traffic route passes. Sub-regions can also be entire urban districts, localities or the surroundings of special traffic nodes.

In method step 12, all the position indications of a route within end sub-regions, i.e. those sub-regions in which at least one end point of the route is contained, are now removed. In said example, all the position indications of the route R1 in sub-region T1 and in sub-region T2 are now removed. The sub-regions T1, T2 thus mask the end points S1, Z1 of the route R1.

In method step 13, the remaining position indications of the route, which in said example are the position indications of the path points that fall in the sub-region T3, are now output for further analysis or even for control. This output can, for example, be sent to an internal storage unit or even to an external device, such as for example an analysis device, or to a central server for route evaluation. A de-anonymization of the remaining route data is now made significantly more difficult or even impossible. The output route data can be processed and analyzed without further security precautions, and therefore more quickly.

The end state 14 of the method is thus reached.

The size, i.e. the geographical or spatial extent, of the determined sub-regions can be chosen dynamically. The size of sub-regions can in particular be chosen depending on a minimum number of end points of various routes that are located within an end sub-region. A certain predeterminable minimum number of routes must thus always begin or end in an end sub-region. In this way it is ensured that even with the knowledge of a first end point, it is not possible, or only possible with difficulty, to deduce the sub-region of the second end point, and thus a possible end point in this second sub-region. This is the case in particular when the various routes that end or begin in an end sub-region follow a different route path.

An end sub-region around, for example, a railway station, bus stop etc. can be chosen to be smaller than an end sub-region surrounding a small, remote residential building. If, after leaving an end sub-region, parts of the route cross over this end-region of the route again, then these parts of the route are not removed, since such a removal brings no further advantages in masking the end point.

The size of the individual sub-regions can accordingly be configured differently. Groups of sub-regions, each with the same size, can however also be configured, wherein the different groups then have different sizes. Alternatively, all the sub-regions can be configured with the same size. In this case, the size of the sub-regions must be configured according to the size of the largest end sub-region that satisfies the required conditions. An uncomplicated division of the geographical region can, for example, be carried out by dividing into quadrants, for example on the basis of longitude and latitude.

FIGS. 5 and 6 show a corresponding exemplary embodiment, in which the division into sub-regions is carried out on the basis of a grid. The geographical region illustrated is divided by means of a grid into quadrants with the coordinates A to D and 1 to 4.

FIG. 5 now shows three different routes R1, R2, R3, each with a first and a second end point S1, Z1, S2, Z2, S3, Z3. With a division of the geographical region illustrated into sub-regions according to the grid shown on the drawing, all the position indications of the routes R1, R2, R3 that end in a sub-region are removed. These end sub-regions are marked separately in FIG. 6, and identified with T4, T5, T6.

The respective end points themselves and all the path points, subsequent to the end point, of the route as far as the edge of the end sub-region T4, T5, T6 are deleted. In the example illustrated, the position indications of route R1, shown dotted, from the end point S1 through to the path point at the edge of the cell T4, are removed from the end sub-region T4. Similarly, the position indications of the route R3, shown with dashes, are removed from the end point S3 through to the edge of the end sub-region T4. The position indications for the path points of the route R2, shown with dashes, which pass into the end sub-region T4 but which pass through it, are retained unchanged. The position indications of route R1 from the end point Z1, of route R2 from the end point Z2, of route R3 from the end point Z3, in each case up to the edge of the end sub-region T5, are removed from the end-sub region T5. The position indications of the route R2 from the end point S2 up to the edge of the end sub-region T6 are removed from the end sub-region T6.

The position indications of route R1, route R2 and route R3, that are given in the sub-regions with coordinates B3, C2 and C3 are retained unchanged; moreover, the position indications of the route R2 in the sub-region with the coordinates B2 and in end sub-region T4, as already explained above, are retained. These position indications can now be output or stored, and output for further analysis or for control purposes. The data can, for example, in future be used by autonomously driving vehicles or devices, in order to guide the vehicle or device on the fastest route.

In one form of embodiment of the method, only end sub-regions are determined in the geographical region in which at least one route under consideration is contained. No sub-regions are determined for the geographical region outside these end sub-regions. The geographical region outside these end sub-regions can also be considered as a single residual sub-region. Inside the end sub-regions, the position indications of the end points and the path points adjacent to the end points of the route under consideration are deleted. Path points lying outside the end sub-regions, and path points that merely pass through the end sub-region, i.e. enter and leave again, are retained.

FIG. 2 now shows a device for providing recorded, anonymized routes which are processed in accordance with the described method.

The device 100 comprises a division unit 101, a masking unit 102, an output unit 103 and, optionally, a memory unit 104. The units are connected together. The device can, for example, be constructed from one or a plurality of microprocessors. The individual units 101, 102, 103, 104 can be integrated into a single physical unit, or, alternatively, be realized in a plurality of physical units that are separate from one another. The memory unit 104 can be designed to be external, for example as a data server. Recorded route data is stored in the memory unit 104 either with or without object-identifying indications. The position data of at least one route, usually however a large number of routes, are provided by the memory unit 104 of the division unit 101, and transmitted to the division unit 101. The division unit 101 can also actively request and read a specific number of routes, or all the routes recorded in a specific time interval, from the memory unit 104. The division unit 101 is designed to divide the geographical region in which the routes that have been read in are contained into at least one sub-region. Division into sub-regions is usually performed iteratively. A first division is performed for this purpose. The division unit 101 now checks whether further conditions for the division of the sub-regions are present. There can, for example, be a condition that the end sub-regions contain a minimum number of end points. In one or a plurality of steps, the division is accordingly adapted to the conditions until all the applicable conditions are satisfied.

In one form of embodiment, the division unit 101 can choose all the sub-regions to have the same size, wherein the size of the sub-regions is determined by the minimum size of the end sub-regions. In another form of embodiment of the division unit 101, the sub-regions, and particularly the end sub-regions, can have different sizes, wherein each individual sub-region must satisfy the underlying conditions. For the geographical region in which no route ends, which is therefore not an end sub-region, sub-regions of any size, or merely one single residual sub-region, can be specified.

The masking unit 102 is designed to remove all the position indications within an end sub-region from the end point up to the first contact with the edge of the masking region. The masking unit 102 now passes on the resulting position indications to an output unit 103. The output unit 103 outputs the route data for further analysis and/or control, for example to an analysis device. In particular, the resulting route data can be stored in the output unit 103. The resulting route data does not have to be stored in encrypted form in order to prevent a de-anonymization, since through the removal of the end segments of the routes, this is already made very difficult or even prevented.

The device 100 can, for example, be integrated into a route acquisition server, or may also be designed as a separate device.

All the features described and/or drawn can advantageously be combined with one another within the scope of the connection. The invention is not restricted to the exemplary embodiments described.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for providing recorded, anonymized routes, each of which indicates a spatial movement of an object from a first end point to a second end point via successive path points and which are recorded by means of a position indication for said path points and anonymized by removing object-identifying data, having the stops of:
dividing a geographical region in which a route is contained into at least one sub-region, removing all the position indications of a route within end sub-regions of the route, i.e. within those sub-regions in which at least one end point of the route is contained, and -outputting the remaining position indications of the route for further analysis and/or control.

2. The method as claimed in claim 1, wherein the size of the end sub-regions is configured in such a way that at least a predeterminable number of end points of routes lies within an end sub-region.

3. The method as claimed in claim 2, wherein all the sub-regions are configured to have the same size.

4. The method as claimed in claim 2, wherein the individual sub-regions are configured with different sizes.

5. The method as claimed in claim 1, wherein the size of the individual sub-regions is configured in accordance with geographical circumstances.

6. The method as claimed in claim 1, wherein only the end point of a route and the path points of the route following the end point as far as the first contact with an edge of the end sub-region are removed.

7. A device for providing a recorded, anonymized route, which records a spatial movement of an object from a first end point to a second end point via successive path points by means of a position indication for said path points and is anonymized by removing object-identifying data, comprising: -a division unit that is designed in such a way as to divide a geographical region in which route is contained into at least one sub-region,
masking unit that is designed in such a way as to remove all the position indications of a route within end sub-regions of the route, i.e. within those sub-regions in which at least one end point of the route is contained, and
an output unit which is designed in such a way as to output the resulting position indications of the route for further analysis and/or control.

8. The device as claimed in claim 7, wherein the division unit, the masking unit, and the output unit.

9. A computer program product comprising a computer readable hardware storage device having computer readable program code stored therein, said program code executable by a processor of a computer system to implement a method that can be loaded directly into a stored-program component, comprising program code segments that are appropriate for carrying out the steps of the method as claimed in claim 1.
